(19) United States
(12) Patent Application Publication
(10) Pub. No.: US 2010/0133120 A1
(43) Pub. Date: Jun. 3, 2010

(54) Electrochemical Sensor

(75) Inventors: Mark Varney, Surrey (GB); Micheal Garrett, Surrey (GB); Deryk Williams, Surrey (GB); Francis Marken, Bath (GB)

Correspondence Address: WILLIAMS MULLEN, 222 CENTRAL PARK AVENUE, SUITE 1700, VIRGINIA BEACH, VA, 23462, US

(73) Assignee: ANAXSYS TECHNOLOGY LTD, Nr Woking, Surrey (GB)

(21) Appl. No.: 12/531,093

(22) PCT Filed: Mar. 17, 2008
(86) PCT No.: PCT/GB2008/000951

§ 371 Date: Feb. 10, 2010

(30) Foreign Application Priority Data
Mar. 15, 2007 (GB) 07049772.9

(51) Int. Cl. G01N 27/26; G01N 27/30

(52) U.S. Cl. 205/785.5; 204/400; 204/412; 205/775

(57) ABSTRACT

An electrochemical sensor (40) is provided, the sensor comprising a working electrode (44); a counter electrode (46); and an ionic liquid medium extending between the working electrode and the counter electrode, the ionic liquid medium comprising an ionic liquid retained in a support material. The ionic liquid may comprise a cation selected from 1-alkyl-3-methylimidazolium ([CₙMIM]), N-alkylpyridinium, tetraalkylammonium or tetraalkylphosphonium cations and an anion selected from hexafluorophosphate [PF₆]; tetrafluoroborate [BF4]; trifluoromethylsulfonate [CF₃SO₃]; bis[(trifluoromethyl)sulfonyl]amide [(CF₃SO₂)₂N]; trifluoroethanoate [CF₃CO₂]; acetate [CH₃CO₂]; nitrate, and halides, including fluoride [F] 1 chloride [Cl], and bromide [Br]. The sensor is particularly useful in the detection of gaseous components in the exhaled breath of a subject and for use in monitoring the lung function of the subject, for example to identify the onset of asthma and/or COPD.

The present invention relates to an electrochemical sensor. The sensor finds use in the detection and monitoring of components in a gaseous stream, including, for example, the analysis and monitoring of the exhaled breath of a subject as a means of determining lung function.

Electrochemical sensors are well known in the art for use in the detection of components in a gaseous medium. The sensors generally comprise at least two electrodes, a working electrode and a counter electrode. The change in electrical impedance between the electrodes is determined, for example by applying a voltage of known value and form across the electrodes, as a result of the sensor being brought into contact with the gaseous medium. In many cases, the electrodes are coated with an electrolytic or semi-conductor material that bridges the electrodes, the conductivity of which changes as a result of contact with the gaseous medium. Some examples of known electrochemical sensors are as follows.

WO 04/001407 discloses a sensor comprising a liquid electrolyte retained by a permeable membrane, which overcomes some of these disadvantages. However, it would be very desirable to provide a sensor that does not rely on the presence and maintenance of a liquid electrolyte.

U.S. Pat. No. 4,772,863 discloses a sensor for oxygen and carbon dioxide gases having a plurality of layers comprising an alumina substrate, a reference electrode source of anions, a lower electrical reference electrode of platinum coupled to the reference source of anions, a solid electrolyte containing tungsten and coupled to the lower reference electrode, a buffer layer for preventing the flow of platinum ions into the solid electrolyte and an upper electrode of catalytic platinum.

GB 2,287,543 A discloses a solid electrolyte carbon monoxide sensor having a first cavity formed in a substrate, communicating with a second cavity in which a carbon monoxide adsorbent is located. An electrode detects the partial pressure of oxygen in the carbon monoxide adsorbent. The sensor of GB 2,287,543 is very sensitive to the prevailing temperature and is only able to measure low concentrations of carbon monoxide at low temperatures with any sensitivity. High temperatures are necessary in order to measure carbon monoxide concentrations that are higher, if complete saturation of the sensor is to be avoided. This renders the sensor impractical for measuring gas compositions over a wide range of concentrations.

GB 2,316,178 A discloses a solid electrolyte gas sensor, in which a reference electrode is mounted within a cavity in the electrolyte. A gas sensitive electrode is provided on the outside of the solid electrolyte. The sensor is said to be useful in the detection of carbon dioxide and sulphur dioxide. However, operation of the sensor requires heating to a temperature of at least 200° C., more preferably from 300 to 400° C. This represents a major drawback in the practical applications of the sensor.

Sensors for use in monitoring gas compositions in heat treatment processes are disclosed in GB 2,184,549 A. However, as with the sensors of GB 2,316,178, operation at high temperatures (up to 600° C.) is disclosed and appears to be required.

Accordingly, there is a need for a sensor that does not rely on the presence of an electrolyte in the liquid phase or high temperature catalytic method, that is of simple construction and may be readily applied to monitor gas compositions at ambient conditions.

EP 0 293 230 discloses a sensor for detecting acidic gases, for example carbon dioxide. The sensor comprises a sensing electrode and a counter electrode in a body of electrolyte. The electrolyte is a solid complex having ligands that may be displaced by the acidic gas. A similar sensor arrangement is disclosed in U.S. Pat. No. 6,454,923.

A particularly effective sensor is disclosed in pending international application No. PCT/GB2005/003196. The sensor comprises a sensing element disposed to be exposed to the gas stream, the sensing element comprising a working electrode; a counter electrode; and a solid electrolyte precursor extending between and in contact with the working electrode and the counter electrode; whereby the gas stream may be caused to impinge upon the solid electrolyte precursor such that water vapour in the gas stream at least partially hydrates the precursor to form an electrolyte in electrical contact with the working electrode and the counter electrode.

Neoteric room-temperature ionic liquids (ILs) are solvents that may have great potential in chemical analysis. They are exciting and unique solvents. Consequently, a variety of analytical applications for ionic liquids have recently started to emerge. Ionic liquids have shown potential as unique solvents with wide range of solubility, miscibility, and other physicochemical properties accompanied by an extremely promising non-volatile behavior. Ionic liquids have shown tremendous applications in a variety of chemical processes and may well become solvents of choice (for example as VOC replacements) for the new millennium with potential as environmentally benign media for many industrially important chemical processes.

Ionic liquids have been used as stable solvents in ionic polymer transducers [M. D. Bennett, D. J. Leo, Sens. Actuators A 115 (2004) 79]. They demonstrated that transducers constructed from a Nafion™ membrane solvated with 1-ethyl-3-methylimidazolium trifluoromethylsulfonate has improved stability when operated in air as compared to the same materials solvated with water. However, the reduction in the speed of the response (as compared to water) was noteworthy.

Dai and coworkers have developed and evaluated the performance of a quartz crystal microbalance device employing room temperature ionic liquids as the ‘sensing material’ for organic vapors [C. Liang, C. Y. Yuan, R. J. Warmack, C. E. Barnes, S. Dai, Anal. Chem. 74 (2002) 2172.]. The sensing mechanism was shown to be based on the rapid decrease in the viscosity of the ionic liquid-based membrane due to solubilization of analytes in the ionic liquid. It was further observed that this change in viscosity was specific to the gaseous chemical species as well as to the type of ionic liquid. The sensors were shown to have a rapid response (<2 s) with excellent reversibility.

The Dai group has systematically measured the solubility of carbon dioxide in a series of imidazolium-based ionic liquids at 25° C. [R. E. Baltus, B. H. Culbertson, S. Dai, H. Luo, D. W. DePaoli, J. Phys. Chem. B 108 (2004) 721]. Similarly, the Gomes group has measured the solubilities of O2, CO, CO2, N2, H2, Ar, CH4 and C2H6 in a single ionic liquid, 1-butyl-3-methylimidazolium hexafluorophosphate, [bmin][PF6] [J. Jacquemin, P. Husson, V. Majer, M. F. Costa Gomes, Fluid Phase Equilibria 240 (2006) 87].

For electroanalytical applications, ionic liquids have wide “electrochemical windows” and large conductivities. Therefore, they have great potential to be used as sensors in electrochemical analysis. Toward specific gas sensing applications, a solid-state amperometric O₂ sensor has been based on a supported hydrophobic bmimPF₆ porous polyethylene membrane as a solid-state electrolyte [R. Wang, S. Hoyano, T. Ohsaka, Chem. Lett. 33 (2004) 6]. In a similar investigation, the same group utilized a different hydrophilic ionic liquid, 1-ethyl-3-methylimidazolium tetrafluoroborate [C₂MIM][BF₄] incorporated into a porous polyethylene membrane [R. Wang, T. Okajima, F. Kitamura, T. Ohsaka, Electroanalysis 16 (2004) 66]. Compared to solid electrolyte gas sensors and classic Clark-type gas sensors, this proposed O₂-gas sensor possesses the advantages of easy construction and miniaturization, wide detection range and stability, as well as applicability at room temperature. The significant drawback of this sensor is that it is restricted to detecting O₂ from a dry gas stream, as moisture can be absorbed by the supported [C₂MIM][BF₄] membrane. However, their negligible vapor pressure and robust thermal stability warrant ionic liquid-based gas sensors operating under extreme conditions, such as high temperature and high pressure.

The presence of water in an ionic liquid can reduce the density and the viscosity but can also modify the chemical properties. In some cases, e.g. PF₆⁻ based salts, traces of water can generate the decomposition of the anion and the formation of HF. Both of these represent undesirable side-effects in gas sensor design. Further, even hydrophobic ionic liquids are hydroscopic (U. Schroder, J. D. Wadhawan, R. G. Compton, F. Marken, P. A. Z. Suarez, C. S. Consorti, R. F. de Souza, J. Dupont, New J. Chem. 24 (2000) 1009). Ionic liquids are usually dried by heating under vacuum. However, water is difficult to remove because of hydrogen bonding.

A review article [M. C. Buzzeo, C. Hardacre, R. G. Compton, Anal. Chem. 76 (2004) 4583] has compared the attainable steady-state limiting currents and time responses of membrane-covered and membrane-independent gas sensors (constituting a variety of electrodes and electrolyte materials). They concluded that while the use of an ionic liquid electrolyte eliminates the need for a membrane and supporting electrolyte, the lower mobility (lower diffusion coefficient) of the gaseous analyte within the more viscous ionic liquid medium results in slower time responses (due to higher ionic liquid viscosities), lengthens the response time and thereby limits the attainable steady-state currents. It was suggested that ionic liquid-based sensors may therefore be more appropriate for extreme operating conditions (e.g., high temperature and pressure) due to their thermal stability and extremely low volatility.

It has now been found that an electrochemical sensor can be provided using an ionic liquid to bridge the electrodes of the sensor, which can be operated under ambient conditions, in particular room temperature and pressure. The sensor has a simple construction and provides a very fast and accurate response to changes in the composition of the gaseous medium being analysed.

Accordingly, in a first aspect, the present invention provides an electrochemical sensor comprising:

a working electrode;

a counter electrode;

an ionic liquid medium extending between the working electrode and the counter electrode, the ionic liquid medium comprising an ionic liquid retained in a support material.

It has been found that the ionic liquid may be retained in a support material, so as to remain in contact with the working electrode and counter electrode. In particular, it has most advantageously been found that the ionic liquid medium can be prepared and applied to the electrodes in a layer with a very low thickness, providing the sensor with a very fast speed of response to changes in the composition of a gaseous medium in contact with the sensor. In a particularly advantageous arrangement, the sensor is provided with a membrane-free interdigitated thick-film screen-printed electrode modified with a thin (nanometer) layer of room temperature ionic liquid incorporated into a thin layer of inert material, in particular TiO₂. The thinness of the layer of inert material is determined by the method of manufacture, and can be made extremely thin and to a high degree of precision. Microscopic layers (in the nanometer region) promote an extremely fast response time of the sensor.

Furthermore, the sensor has a long shelf life because of the zero or near zero vapour pressure and stable chemical properties of ionic liquids, which eliminate the possibility of loss of these liquids through vaporization and chemical reaction. The manufacturing method is also simple.

Ionic liquids, resulting from the combination of organic cations and various anions, are salts with melting points of below ca. 100° C. Some ionic liquids are liquid at over 400° C., and some are liquid at as low as −96° C. One of the advantages arising from the chemical structures of ionic liquids is that alteration of the cation or anion changes properties such as: viscosity, melting point, water miscibility, and density. Ionic liquids have negligible vapor pressure, over a considerably wide range of temperatures. They are non-flammable and exhibit good solubility for inorganic and organic compounds. Air- and moisture-stable ionic liquids are of particular interest because they can be easily handled and used in a wide variety of environments. Performing chemistry in a non-molecular environment is currently still a novel concept because relatively little is known about the ionic liquids themselves.

Any suitable ionic liquid may be employed in the sensor of the present invention. The ionic liquid medium may comprise one or a mixture of two or more ionic liquids. The cation of the ionic liquid is organic. Suitable ionic liquids include those comprising the organic 1-alkyl-3-methylimidazolium ([CₙMIM]), N-alkylpyridinium, tetraalkylammonium or tetraalkylphosphonium cations. Ionic liquids comprising a 1-alkyl-3-methylimidazolium ([CₙMIM]) cation are particularly preferred for use in the sensor of the present invention. The alkyl group may be any suitable alkyl group, with C₁ to C₁₀ alkyls being preferred, more preferably from C₁ to C₆, especially from C₁ to C₄. A particularly preferred cation is 1-butyl-3-methylimidazolium (BMIM).

The ionic liquid may comprise any suitable anion. The anions may be either organic or inorganic. Examples of suitable anions include hexafluorophosphate [PF₆]; tetrafluoroborate [BF₄]; trifluoromethylsulfonate [CF₃SO₃]; bis[(trifluoromethyl) sulfonyl]amide [(CF₃SO₂)₂N]; trifluoroethanoate [CF₃CO₂]; acetate [CH₃CO₂]; nitrate, and halides, including fluoride [F], chloride [Cl], and bromide [Br]. Preferred anions for use in the ionic liquid of the sensor of the present invention include hexafluorophosphate [PF₆].

The components that form the basis of most room-temperature ionic liquids are summarized below.

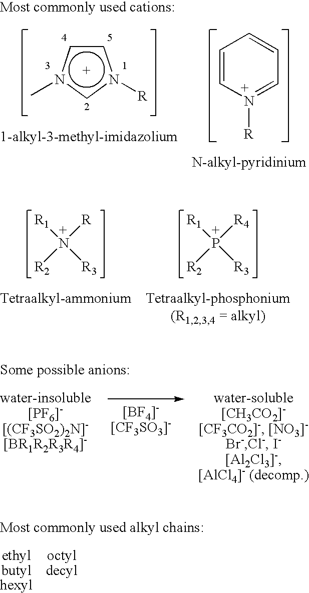

The anion mainly determines the solubility with water. For example, for the same 1-butyl-3-methylimidazolium cation, the BF₄⁻, CF₃SO₃⁻, CF₃CO₂⁻, NO₃⁻, and halide salts display a complete miscibility with water at 25° C. The PF₆⁻, SbF₆⁻, NTf₂⁻, BR₄⁻ anions show a very low miscibility with water. However, for the PF₆⁻ based melt, the shorter symmetric substituted 1,3-dimethylimidazolium PF₆⁻ salt becomes water-soluble.

For a series of 1-alkyl-3-methylimidazolium cations, decreasing the alkyl chain length from octyl to butyl decreases the hydrophobicity and the viscosity of the ionic liquid, whereas densities and surface tension values increase. Salts based on the 1,3-dialkylimidazolium cation are generally preferred as they generally interact weakly with the anions and are more thermally stable than other quaternary ammonium cations.

Some typical physical characteristics of the more currently used 1-butyl-3-methylimidazolium ionic liquids are given in the table below.

TABLE

| | Melting | | | |
|---|---|---|---|---|
| | Point | Density | Viscosity | Conductivity |
| Anion | (° C.) | (g cm⁻³) | (mPas) | (Sm⁻¹) |
| BF₄⁻ | −82/−83 | 1.17 (30° C.) | 233 (30° C.) | 0.173 (25° C.) |
| PF₆⁻ | −61 | 1.37 (30° C.) | 312 (30° C.) | 0.146 (25° C.) |
| CF₃SO₃⁻ | 16 | 1.290 (20° C.) | 90 (20° C.) | 0.37 (20° C.) |
| CF₃CO₂⁻ | −50/−30 | 1.209 (21° C.) | 73 (20° C.) | 0.32 (20° C.) |
| NTf₂⁻* | −4 | 1.429 (19° C.) | 52 (20° C.) | 0.39 (20° C.) |

*NTf₂ is bis(trifluoromethanesulfonyl)amide

Many, if not most, ionic liquids will work in the sensor of the present invention. A most preferred ionic liquid is [BMIM][PF₆], as indicated above.

The ionic liquid medium comprises the ionic liquid retained in a support material. The support material provides a physical support to retain the ionic liquid in place and in contact with the electrodes. The support material is most preferably an inert material, that is does not interact chemically with either the ionic liquid or the components of the gaseous medium. In such a case, the interaction between the ionic liquid and the support is a mechanical or physical one, with little or no chemical or electrochemical interaction occurring.

The support material may be any suitable material, preferably inert, that can physically contain and retain the ionic liquid in sufficient amounts to ensure an adequate electrical path between the electrodes. The support material may retain the ionic liquid by any suitable means. Preferably, the support material is porous, with pores of a size that can retain the ionic liquid. In such a structure, the ionic liquid may enter and be held in the pores of the support material by capillary action. The support material may also be granular or reticulated, such that interstices are present between the granules of the material which, again, may contain the ionic liquid as a result of capillary action.

Suitable support materials are materials that are sufficiently porous and/or materials that may be granulated or reticulated to form pores sufficient to contain the ionic liquid. Examples of suitable support materials are mesoporous materials, that is materials have pores with a diameter in the range of from 1 to 75 nm, more particularly in the range of from 2 to 50 nm. Examples of mesoporous materials include zeolites and clays. Suitable zeolites and clays are known and available commercially. Further examples of suitable support materials include metal oxides, such as titanium oxide (TiO₂), aluminium oxide (Al₂O₃), zirconium oxide (zirconia, Zr₂O₄), and silicon oxide (silica, SiO₂), or mixtures thereof, such as silica-alumina. Particularly preferred support materials include titanium oxide (TiO₂) and silica gel.

Titanium oxide (TiO₂) is a particularly preferred support material. The TiO₂ has mostly a spherical/granular nature, and therefore has an extremely high surface area. This is simply a physical support, with no other chemical interaction with the target species or the ionic liquid. The TiO₂ plays no other part in the sensor chemistry, apart from simply acting as a physical support for the reactions within the ionic liquid.

The sensor of the present invention further comprises a plurality of electrodes. The sensor comprises at a minimum at least a working electrode and a counter electrode. When using just two electrodes, the reduction potential of the sensor may be very high, resulting in difficulty in maintaining adequate potentiostatic control of the voltage. As a result, it may be preferred to provide at least three electrodes in the sensor, a working electrode, a counter electrode and a reference electrode. The use of a reference electrode provides for better potentiostatic control of the applied voltage, or the galvanostatic control of current, when the “iR drop” between the counter and working electrodes is substantial. Dual 2-electrode and 3-electrode cells may also be employed.

The electrodes may have any suitable shape and configuration. Suitable forms of electrode include points, lines, rings and flat planar surfaces. The effectiveness of the sensor can depend upon the particular arrangement of the electrodes and may be enhanced in certain embodiments by having a very small path length between the adjacent electrodes. This may be achieved, for example, by having each of the working and counter electrodes comprise a plurality of electrode portions arranged in an alternating, interlocking pattern, that is in the form of an array of interdigitated electrode portions, in particular arranged in a concentric pattern.

The electrodes are preferably oriented as close as possible to each other, to within the resolution of the manufacturing technology. The working and counter electrode can be between 10 to 1000 microns in width, preferably from 50 to 500 microns. The gap between the working and counter electrodes can be between 20 and 1000 microns, more preferably from 50 to 500 microns. The optimum track-gap distances are found by routine experiment for the particular electrode material, geometry, configuration, and substrate under consideration. In a preferred embodiment the optimum working electrode track widths are from 50 to 250 microns, preferably about 100 microns, and the counter electrode track widths are from 50 to 750 microns, preferably about 500 microns. The gaps between the working and counter electrodes are preferably about 100 microns.

The counter electrode and working electrode may be of equal size. However, in one preferred embodiment, the surface area of the counter electrode is greater than that of the working electrode to avoid restriction of the current transfer. Preferably, the counter electrode has a surface area at least twice that of the working electrode. Higher ratios of the surface area of the counter electrode and working electrode, such as at least 3:1, preferably at least 5:1 and up to 10:1 may also be employed. The thickness of the electrodes is determined by the manufacturing technology, but has no direct influence on the electrochemistry. The magnitude of the resultant electrochemical signal is determined principally by exposed surface area, that is the surface area of the electrodes directly exposed to and in contact with the gaseous stream. Generally, an increase in the surface area of the electrodes will result in a higher signal, but may also result in increased susceptibility to noise and electrical interference. However, the signals from smaller electrodes may be more difficult to detect.

The electrodes may be supported on a substrate. Suitable materials for the support substrate are any inert, non-conducting material, for example ceramic, plastic, or glass. The substrate provides support for the electrodes and serves to keep them in their proper orientation. Accordingly, the substrate may be any suitable supporting medium. It is important that the substrate is non-conducting, that is electrically insulating or of a sufficiently high dielectric coefficient. Further, the selection of the substrate material may be influenced by the properties of the ionic liquid being employed. For example the more highly hydrophobic ionic liquids may perform better on certain substrates that have a greater affinity for the ionic liquid.

The electrodes may comprise any suitable metal or alloy of metals. Preference is given to metals in Group VIII of the Periodic Table of the Elements (as provided in the Handbook of Chemistry and Physics, 62^{nd} edition, 1981 to 1982, Chemical Rubber Company). Preferred Group VIII metals are iridium, rhenium, palladium and platinum. Other suitable metals include copper, indium, rubidium, silver and gold. Preferably, each electrode is prepared from gold or platinum. Carbon, for example diamond-like carbon, or carbon-containing materials may also be used to form the electrodes, as well as materials containing carbon fibres or carbon nanotubes.

Depending upon the intended application of the sensor, copper may be a preferred metal for forming one or all of the electrodes. Copper can have superior properties (i.e. greater Faradaic efficiency), in certain applications, for example in the reduction of CO₂. However, the copper electrode may be poisoned by the continuous electroreduction of CO₂, and so a periodic, pulsed or transient method of analysis, as opposed to a continuous operation, may be preferable, in order to ensure a satisfactory working lifetime for the sensor.

The ionic liquid medium is present in the sensor as a layer or coating, covering and extending over the electrodes, such that the ionic liquid is in electrical contact with each electrode and forms an electrical path between the electrodes. The sensor operates due to changes in the impedance, in particular resistance and capacitance of the ionic liquid path between the electrodes as a result of an interaction between the ionic liquid and the target species or component in the gaseous medium being analysed or monitored.

It has been found that the thickness of the layer of ionic liquid medium on the electrodes determines the rate at which the gas reaches the working electrode surface and therefore the overall speed of response of the sensor to changes in the composition of the gaseous medium. Thin layers of the ionic liquid medium are therefore preferred. In particular, the layer of ionic liquid medium is preferably less than 1 micron thick, preferably less than 500 nm thick, even more preferably less than 300 nm, with a thickness of less than 200 nm being especially preferred. A layer having a thickness of from 50 to 200 nm is particularly suitable, with a layer of material having a thickness of 100 nm or less being especially suitable. The speed of response (i.e. the time to 95% of full scale signal due to a step change in concentration) is 0.01 s for a 100 nm thickness layer of the ionic liquid medium.

In addition to the ionic liquid and the support material, the ionic liquid medium may comprise additional components, as follows.

First, the ionic liquid medium may comprise one or more electrochemical reducing agents, to enhance the electrochemical reduction of the target species in the ionic liquid medium at the electrodes. The electrochemical reducing agent may be any suitable component that reacts with the target species, and its selection may depend upon the species being targeted by the sensor. Quinone and quinoline and their derivatives are most suitable electrochemical reducing agents, particularly in the case of the target species being carbon dioxide. The quinone and quinoline derviatives are preferably substituted, for example with electron withdrawing substituents that polarize the molecule, enhancing its reactivity with the target species. Preferred substituents are alkyl groups having from 2 to 10 carbon atoms, especially branched alkyl groups having from 3 to 10 carbon atoms, more preferably branched alkyl groups having from 3 to 8 carbon atoms. A particularly preferred substituent is tertiary butyl. One especially preferred reducing agent is tertiary-butyl substituted benzoquinone, in particular 3,5-di-tertiarybutyl benzoquinone. Other suitable reducing agents for inclusion in the ionic liquid medium include substituted 1,2-benzoquinones and substituted hydroxyquinolines.

The amount of reducing agent present will depend upon such factors as the target species, the ionic liquid, and the reducing agent concerned. If present, the electrochemical reducing agent is preferably present in a volume ratio to the ionic liquid of from 1:1 to 10:1, more preferably from 2:1 to 6:1, even more preferably from 3:1 to 5:1. A volume ratio of reducing agent to ionic liquid of about 4:1 is particularly preferred.

Further, the ionic liquid medium may comprise one or more co-solvents, in addition to the ionic liquid. The co-solvent facilitates the electrochemical recuction reactions of the target species in the ionic liquid medium and has been found to be required when targeting certain species. For example, a co-solvent is generally required to provide an acceptable level of response of the sensor in the case of detecting carbon dioxide. For example, the presence of a suitable co-solvent in the ionic liquid medium significantly enhances the electro-reduction reaction of carbon dioxide and quinine. In the absence of the co-solvent, it has been found that the reaction proceeds, but at a significantly reduced rate. As a result, the co-solvent is required if the sensor is to have a rapid response time and be able to react to rapid changes in the concentration of the target species in the gaseous medium being analysed or monitored.

The co-solvent is preferably selected to have chemical properties, such as being polar and aprotic, which are close to, but not the same as those of the ionic liquid. Preferred co-solvents are organic nitrogen-containing compounds and include pyridines, pyrimidines, amines, diamines and triamines, and their derivatives. Pyridines are particularly preferred co-solvents and examples include pyridine and substituted pyridine compounds. Suitable substituents include alkyl, aryl and acyl groups, in particular alkyl groups having from 1 to 8 carbon atoms, more preferably from 2 to 6 carbon atoms. Pyridine derivatives bearing phenyl and diphenyl substituents are also suitable co-solvents. One particularly preferred co-solvent is 4-(3-phenylpropyl)pyridine.

The amount of co-solvent present will depend upon such factors as the target species, the ionic liquid, and the co-solvent concerned. If present, the co-solvent is preferably present in a volume ratio to the ionic liquid of from 0.1:1 to 3:1, more preferably from 0.2:1 to 2:1, even more preferably from 0.5:1 to 1.5:1. A volume ratio of reducing agent to ionic liquid of about 1:1 is particularly preferred.

The ionic liquid medium may also comprise one or more components active in catalyzing the redox reactions. Suitable redox catalysts are known in the art. Copper-containing compounds are preferred redox catalysts, in particular copper halides, with copper (II) chloride and copper (II) bromide being especially preferred. Other suitable copper salts include copper (II) acetate.

The amount of redox catalyst present will depend upon such factors as the target species, the ionic liquid, and the redox catalyst concerned. If present, the redox catalyst is preferably present in a concentration ratio to the ionic liquid of from 0.01:1 to 0.5:1, more preferably from 0.02:1 to 0.3:1, even more preferably from 0.05:1 to 0.2:1. A volume ratio of reducing agent to ionic liquid of about 0.1:1 is particularly preferred.

The sensor may also benefit from the presence in the ionic liquid of one or more further organic solvents, in particular alcohols, especially n-alkanols. Preferred n-alkanols are those having from 1 to 10 carbon atoms, more preferably from 2 to 8 carbon atoms, especially from 3 to 6 carbon atoms. n-butanol is a particularly preferred organic solvent, which has been found to cooperate particularly well in the catalysis of the reaction between benzoquinone and carbon dioxide, for example.

The amount of organic solvent present will depend upon such factors as the target species, the ionic liquid, and the organic solvent concerned. If present, the organic solvent is preferably present in a volume ratio to the ionic liquid of from 0.01:1 to 0.1:1, more preferably from 0.02:1 to 0.08:1, even more preferably from 0.03:1 to 0.06:1. A volume ratio of reducing agent to ionic liquid of about 0.05:1 is particularly preferred.

The ionic liquid medium may be prepared by any suitable method. For example, in a first method, a layer of the support material is formed on the sensor and the ionic liquid, together with any additional components to be employed, applied to the thus formed layer. Alternatively, the sensor having a layer of support material may be contacted with the ionic liquid, for example by dipping the sensor element in a reservoir of the ionic liquid, for sufficient time to allow the ionic liquid to be taken up into the support material. The ionic liquid may contain any further components to be included in the ionic liquid medium, as described above. As a further alternative, a liquid composition may be formed comprising the ionic liquid, any additional components to be included, as described above, a precursor for the support material, and a solvent. The liquid may be applied to the sensor so as to coat the electrodes to the required thickness, after which the solvent is allowed to evaporate or removed under reduced pressure, to leave the solid support material with the retained liquid components. In this process, the ionic liquid becomes retained in the pores of the support material or in the interstices between the support material particles, as the solvent evaporates and the solid layer forms.

As noted hereinbefore, the ionic liquid provides an electrical connection between the electrodes of the sensor and it is the changes in the impedance of this electrical connection in response to changes in the composition of the gaseous medium being analysed that are measured in the sensor. As a result, the precise form of the surface of the ionic liquid medium is largely unimportant and may be any suitable form, for example smooth, ridged, or corrugated.

The sensor preferably comprises a housing or other protective body to enclose and protect the electrodes. The sensor may comprise a passage or conduit to direct the stream of gas directly onto the electrodes. In a very simple arrangement, the sensor comprises a conduit or tube into which the two electrodes extend, so as to be contacted directly by the gaseous stream passing through the conduit or tube. When the sensor is intended for use in the analysis of the breath of a patient, the conduit may comprise a mouthpiece, into which the patient may exhale. Alternatively, the sensor may be formed to have the electrodes in an exposed position on or in the housing, for direct measurement of a bulk gas stream. The precise form of the housing, passage or conduit is not critical to the operation or performance of the sensor and may take any desired form. It is preferred that the body or housing of the sensor is prepared from a non-conductive material, such as a suitable plastic.

To improve the electrical insulation of the electrodes, the portions of the electrodes that are not disposed to be in contact with the gaseous stream (that is the non-operational portions of the electrodes) may be coated with a dielectric material, patterned in such a way as to leave exposed the active portions of the electrodes.

A further electrode, disposed between the counter and working electrodes, may also be employed. The temperature of the gas stream may be calculated by measuring the end-to-end resistance of the electrode. Such techniques are known in the art.

The electrodes of the sensor of the present invention may be formed by printing the electrode material in the form of a thick film screen printing ink onto the substrate. The ink consists of four components, namely the functional component, a binder, a vehicle and one or more modifiers. In the case of the present invention, the functional component forms the conductive component of the electrode and comprises a powder of one or more of the aforementioned metals used to form the electrode.

The binder holds the ink to the substrate and merges with the substrate during high temperature firing. The vehicle acts as the carrier for the powders and comprises both volatile components, such as solvents and non-volatile components, such as polymers. These materials evaporate during the early stages of drying and firing respectively. The modifiers comprise small amounts of additives, which are active in controlling the behaviour of the inks before and after processing.

Screen printing requires the ink viscosity to be controlled within limits determined by rheological properties, such as the amount of vehicle components and powders in the ink, as well as aspects of the environment, such as ambient temperature.

The printing screen may be prepared by stretching stainless steel wire mesh cloth across the screen frame, while maintaining high tension. An emulsion is then spread over the entire mesh, filling all open areas of the mesh. A common practice is to add an excess of the emulsion to the mesh. The area to be screen printed is then patterned on the screen using the desired electrode design template.

The squeegee is used to spread the ink over the screen. The shearing action of the squeegee results in a reduction in the viscosity of the ink, allowing the ink to pass through the patterned areas onto the substrate. The screen peels away as the squeegee passes. The ink viscosity recovers to its original state and results in a well defined print. The screen mesh is critical when determining the desired thick film print thickness, and hence the thickness of the completed electrodes.

The mechanical limit to downward travel of the squeegee (downstop) should be set to allow the limit of print stroke to be 75-125 um below the substrate surface. This will allow a consistent print thickness to be achieved across the substrate whilst simultaneously protecting the screen mesh from distortion and possible plastic deformation due to excessive pressure.

To determine the print thickness the following equation can be used:

Tw=(Tm×Ao)+Te

Where
Tw=Wet thickness (um);
Tm=mesh weave thickness (um);
Ao=% open area;
Te=Emulsion thickness (um).

After the printing process the sensor element needs to be leveled before firing. The leveling permits mesh marks to fill and some of the more volatile solvents to evaporate slowly at room temperature. If all of the solvent is not removed in this drying process, the remaining amount may cause problems in the firing process by polluting the atmosphere surrounding the sensor element. Most of the solvents used in thick film technology can be completely removed in an oven at 150° C. when held there for 10 minutes.

Firing is typically accomplished in a belt furnace. Firing temperatures vary according to the ink chemistry. Most commercially available systems fire at 850° C. peak for 10 minutes. Total furnace time is 30 to 45 minutes, including the time taken to heat the furnace and cool to room temperature. Purity of the firing atmosphere is critical to successful processing. The air should be clean of particulates, hydrocarbons, halogen-containing vapours and water vapour.

Alternative techniques for preparing the electrodes and applying them to the substrate, if present, include spin/sputter coating and visible/ultraviolet/laser photolithography. In order to avoid impurities being present in the electrodes, which may alter the electrochemical performance of the sensor, the electrodes may be prepared by electrochemical plating. In particular, each electrode may be comprised of a plurality of layers applied by different techniques, with the lower layers be prepared using one of the aforementioned techniques, such as printing, and the uppermost or outer layer or layers being applied by electrochemical plating using a pure electrode material, such as a pure metal.

In use, the sensor of the present invention requires that an electric potential is applied across the electrodes. In one simple configuration, a voltage is applied to the counter electrode, while the working electrode is connected to earth (grounded). In its simplest form, the method applies a single, constant potential difference across the working and counter electrodes. Alternatively, the potential difference may be varied against time, for example being pulsed or swept between a series of potentials. In one embodiment, the electric potential is pulsed between a so-called ‘rest’ potential, at which no reaction occurs, and a reaction potential.

In operation, a linear potential scan, multiple voltage steps or one discrete potential pulse are applied to the working electrode, and the resultant Faradaic reduction current is monitored as a direct function of the dissolution of target molecules in the ionic liquid bridging the electrodes.

The measured current in the sensor element is usually small. The current is converted to a voltage using a resistor, R. As a result of the small current flow, careful attention to electronic design and detail may be necessary. In particular, special “guarding” techniques may be employed. Ground loops need to be avoided in the system. This can be achieved using techniques known in the art.

The current that passes between the counter and working electrodes is converted to a voltage and recorded as a function of the concentration of the target species in the gaseous stream. The sensor responds faster by pulsing the potential between two voltages, a technique known in the art as ‘Square Wave Voltammetry’. Measuring the response several times during a pulse may be used to assess the impedance of the sensor.

The shape of the transient response can be simply related to the electrical characteristics (impedance) of the sensor in terms of simple electronic resistance and capacitance elements. By careful analysis of the shape, the individual contributions of resistance and capacitance may be calculated. Such mathematical techniques are well known in the art. Capacitance is an unwanted noisy component resulting from electronic artifacts, such as charging, etc. The capacitive signal can be reduced by selection of the design and layout of the electrodes in the sensor. Increasing the surface area of the electrodes and increasing the distance between the electrodes are two major parameters that affect the resultant capacitance. The desired Faradaic signal resulting from the passage of current due to reaction between the electrodes may be optimized, by experiment. Measurement of the response at increasing periods within the pulse is one technique that can preferentially select between the capacitive and Faradaic components, for instance. Such practical techniques are well known in the art.

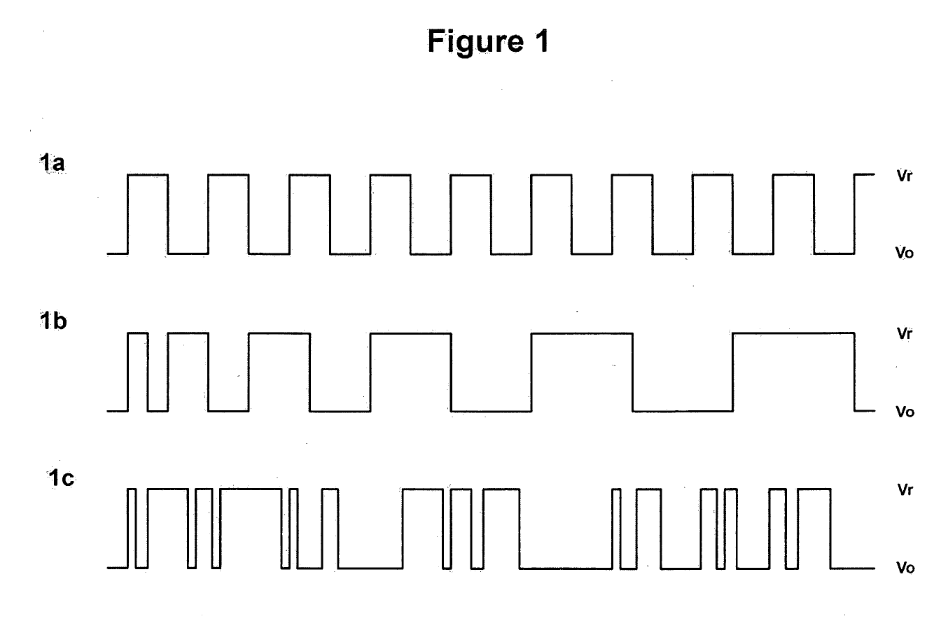

The potential difference applied to the electrodes of the sensor element may be alternately or be periodically pulsed between a rest potential and a reaction potential, as noted above. FIG. 1 shows examples of voltage waveforms that may be applied. FIG. 1a is a representation of a pulsed voltage signal, alternating between a rest potential, V₀, and a reaction potential V_{R}. The voltage may be pulsed at a range of frequencies, typically from sub-Hertz frequencies, that is from 0.1 Hz, up to 10 kHz. A preferred pulse frequency is in the range of from 1 to 500 Hz. Alternatively, the potential waveform applied to the counter electrode may consist of a “swept” series of frequencies, represented in FIG. 1b. A further alternative waveform shown in FIG. 1c is a so-called “white noise” set of frequencies. The complex frequency response obtained from such a waveform will have to be deconvoluted after signal acquisition using techniques such as Fourier Transform analysis. Again, such techniques are known in the art.

One preferred voltage regime is 0V (“rest” potential), 250 mV (“reaction” potential), and 20 Hz pulse frequency.

The sensor of the present invention may be used to detect the presence of a wide range of gaseous components. One particular component is carbon dioxide. Carbon dioxide (CO₂) can be electrochemically reacted in a number of ways. The easiest and simplest is to reduce the gas at sufficiently negative potentials. Unfortunately, this cannot be achieved in water because water is molecularly reduced before carbon dioxide, resulting in the decomposition of the water into hydrogen and oxygen. Replacing the water with an aprotic solvent extends the electrochemical reaction window sufficiently such that the carbon dioxide reduction wave can be discerned on its own (without background interference).

Carbon dioxide can be directly reduced at the surface of the working electrode in the sensor of the present invention. Typical voltages necessary to promote the reduction would be any potential greater than −1.5V. A concentration gradient at the working electrode would be set up, in just the same way as in water. The concentration gradient causes the continued diffusion of the carbon dioxide gas within the ionic liquid up to the electrode surface.

The reduction results in a number of products. However, carbon dioxide will not be fully reduced to methane (CH₄). The reduction products will be a mixture/variety of (undetermined) intermediate products such as carbon monoxide, oxalic acid, methanol, formic acid and some ionic products, some of which will also be gaseous. Other products will dissolve in the ionic liquid. The exact nature of the intermediates depends on many factors, such as the electrode material, electrolyte composition, and pH. The thinness of the layer of ionic liquid within the support material matrix also facilitates the diffusion of the reaction products back into the sampling atmosphere.

The sensor of the present invention may be used to detect a wide range of chemical components and species present in a gaseous medium. The sensor is particularly suitable for the detection of components in a high oxidation state, that is readily able to undergo electrochemical reduction within the ionic liquid medium at the electrodes of the sensor. As noted above, one particular target molecule is carbon dioxide, in which the carbon atom is in its highest oxidation state. Other target species that can be detected in a gaseous medium using the sensor of the present invention include oxygen and sulphur oxides, in particular sulphur dioxide (SO₂). Oxides of phosphor may also be detected.

The sensor and method of the present invention are of use in monitoring and determining the lung function of a patient or subject. The method and sensor are particularly suitable for analyzing tidal concentrations of a range of components, for example carbon dioxide, in the exhaled breath of a person or animal, to diagnose or monitor a variety of respiratory conditions. The sensor is particularly useful for applications requiring fast response times, for example personal respiratory monitoring of tidal breathing (capnography). Capnographic measurements can be applied generally in the field of respiratory medicine, airway diseases, both restrictive and obstructive, airway tract disease management, and airway inflammation. The present invention finds particular application in the field of capnography and asthma diagnosis, monitoring and management, where the shape of the capnogram changes as a function of the extent of the disease. In particular, due to the high rate of response that may be achieved using the sensor and method of the present invention, the results may be used to provide an early alert to the onset of an asthma attack in an asthmatic patient.

Embodiments of the present invention will now be described, by way of example only, having reference to the accompanying drawings, in which:

FIGS. 1a, 1b and 1c are voltage versus time representations of possible voltage waveforms that may be applied to the electrodes in the method of the present invention, as discussed hereinbefore;

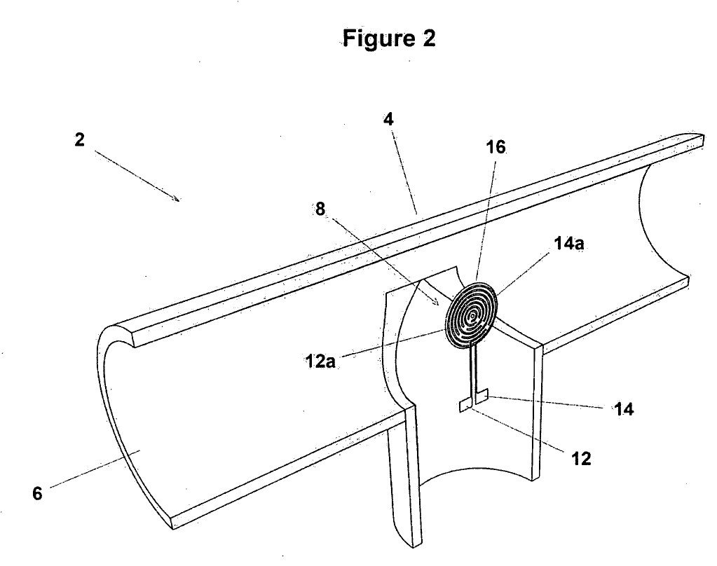

FIG. 2 is a cross-sectional representation of one embodiment of the sensor of the present invention;

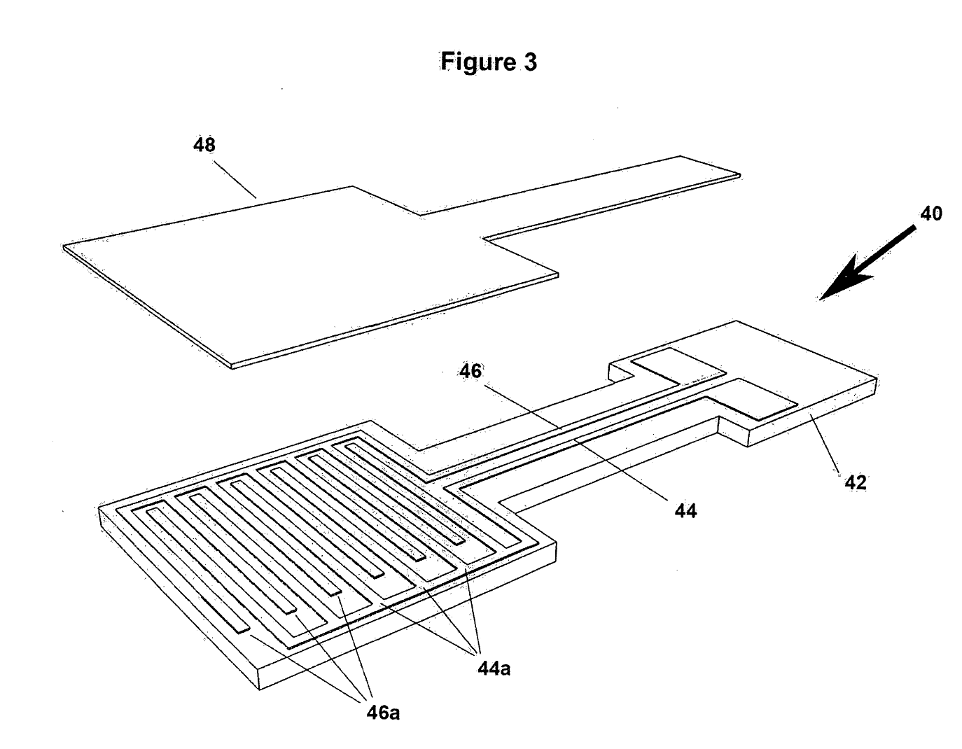

FIG. 3 is an isometric schematic view of a face of one embodiment of the sensor element according to the present invention;

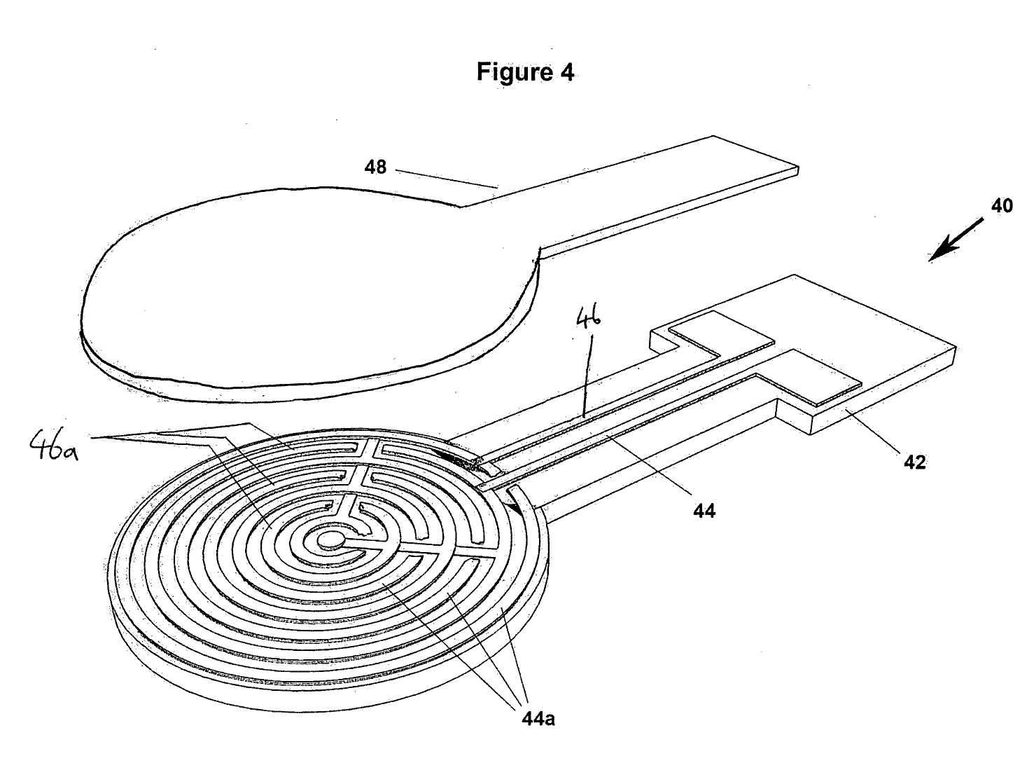

FIG. 4 is an isometric schematic view of an alternative embodiment of the sensor element of the sensor of the present invention;

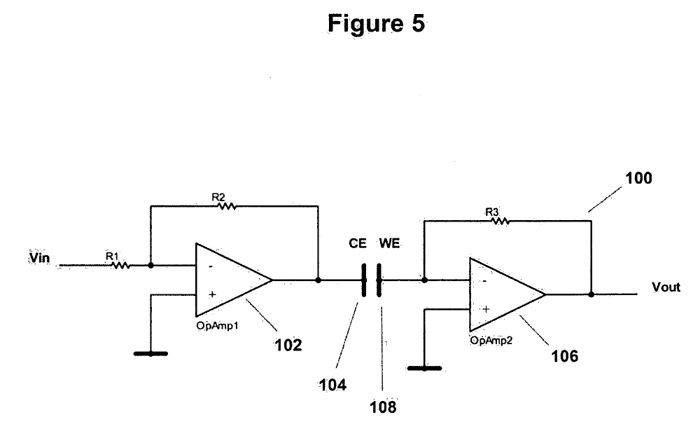

FIG. 5 is a schematic view of a potentiostat electronic circuit that may be used to excite the electrodes of the sensor element;

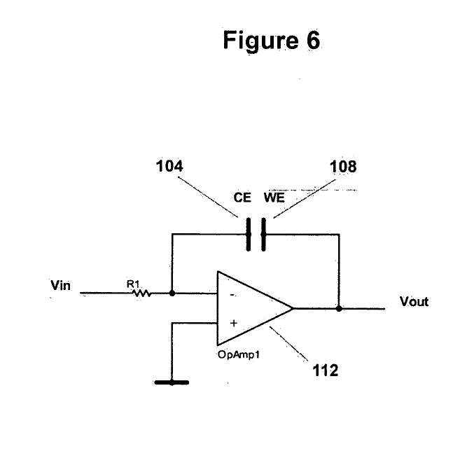

FIG. 6 is a schematic view of a galvanostat electronic circuit that may be used to excite the electrodes;

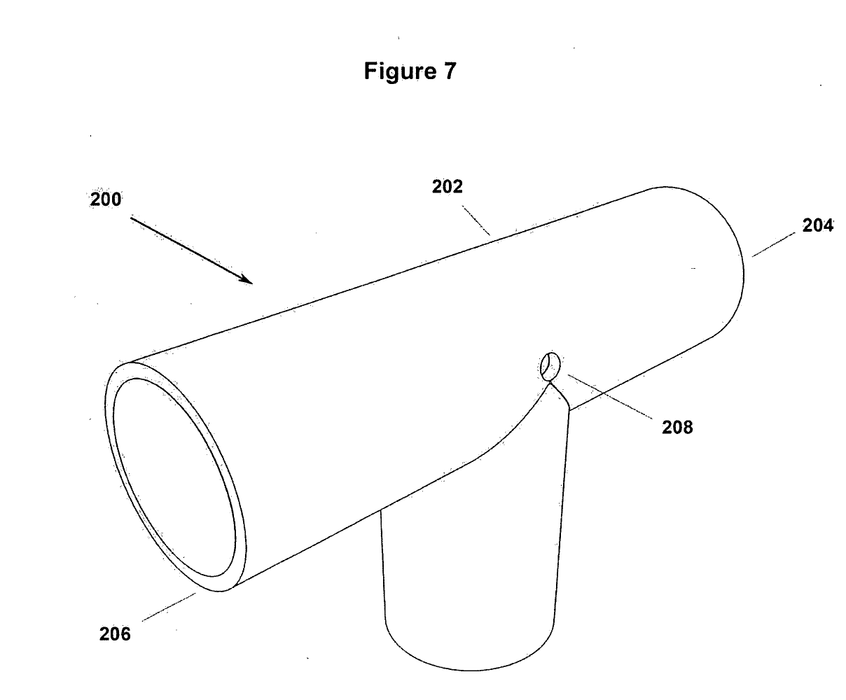

FIG. 7 is a schematic representation of a breathing tube adaptor for use in the sensor of the present invention;

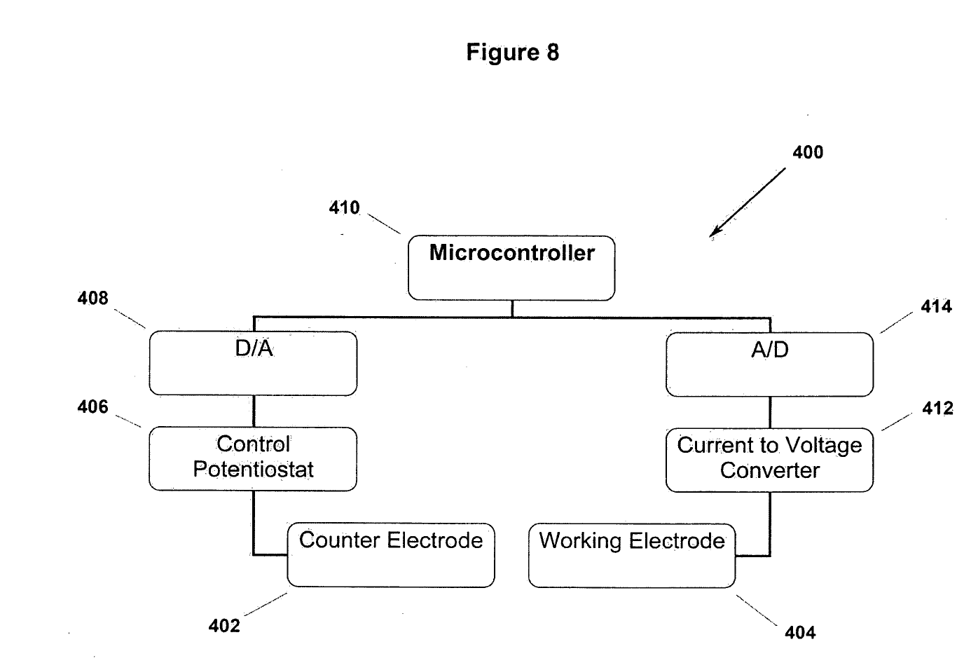

FIG. 8 is a flow-diagram providing an overview of the inter-connection of sensor elements and their connection into a suitable measuring instrument of an embodiment of the present invention;

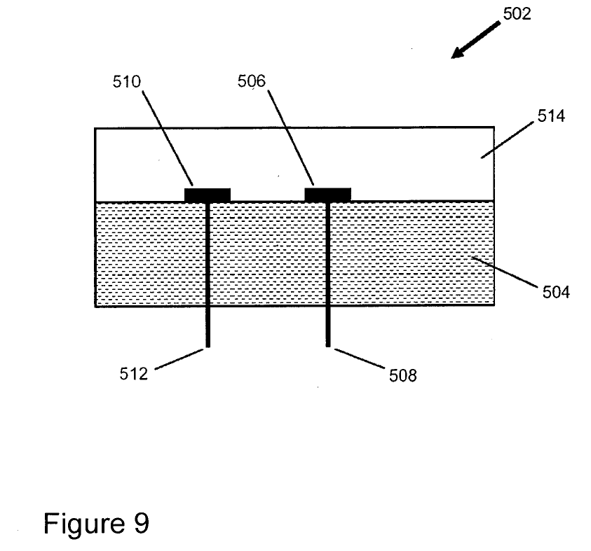

FIG. 9 is a diagrammatical cross-sectional view of a portion of a sensor of one embodiment of the present invention;

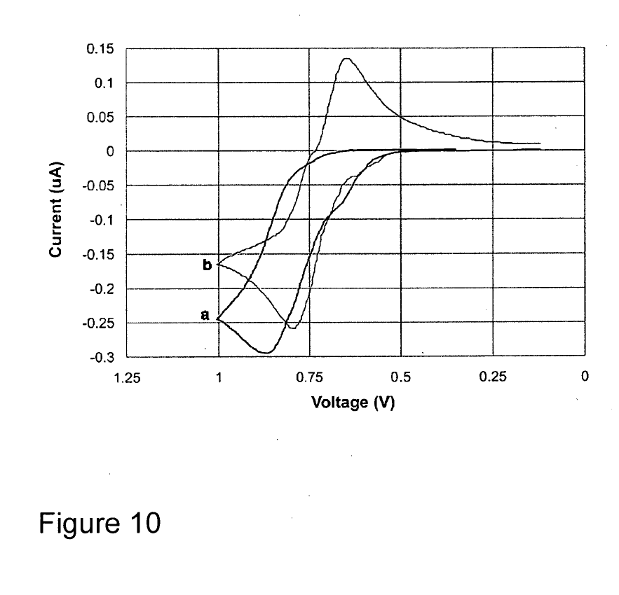

FIG. 10 is a graphical representation of the output of a sensor according to the present invention in a first experiment to detect carbon dioxide in a gas stream compared with a control gas stream;

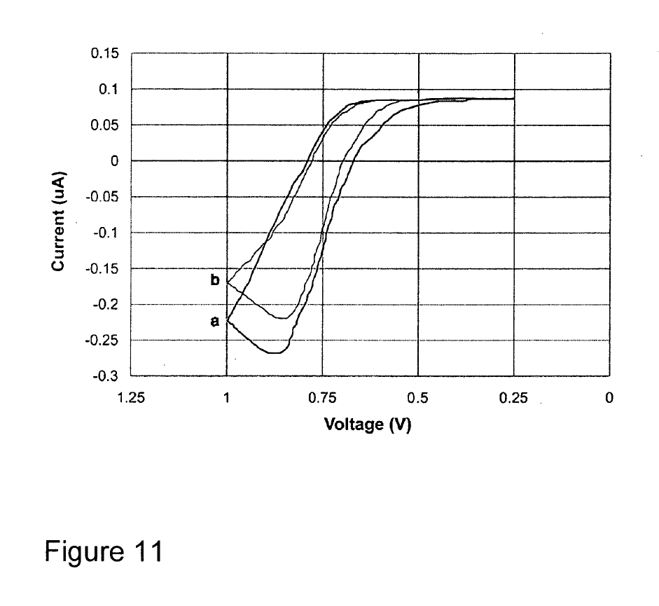

FIG. 11 is a graphical representation of the output of a sensor according to the present invention in a second experiment to detect carbon dioxide; and

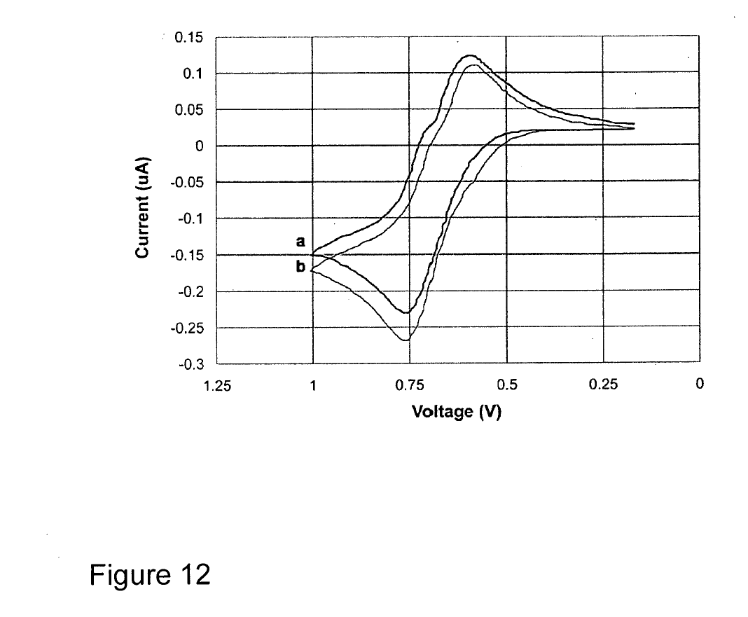

FIG. 12 is a graphical representation of the output of the sensor of the second experiment when exposed to a control gas stream for comparison purposes.

Referring to FIG. 2, there is shown a sensor according to the present invention. The sensor may be used for analyzing the components, for example carbon dioxide, of exhaled breath. The sensor, generally indicated as 2, comprises a conduit 4, through which a stream of exhaled breath may be passed. The conduit 4 comprises a mouthpiece 6, into which the patient may breathe.

A sensing element, generally indicated as 8; is located within the conduit 4, such that a stream of gas passing through the conduit from the mouthpiece 6 is caused to impinge upon the sensing element 8. The sensing element 8 comprises a support substrate 10 of an inert material, onto which is mounted a working electrode 12 and a counter electrode 14. The working electrode 12 and counter electrode 14 each comprise a plurality of electrode portions, 12a and 14a, arranged in concentric circles, so as to provide an interwoven pattern minimizing the distance between adjacent portions of the working electrode 12 and the counter electrode 14. In this way, the current path between the two electrodes is kept to a minimum.

A layer 16 of ionic liquid medium extends over both the working and counter electrodes 12 and 14, in particular covering the portions 12a and 14a of each electrode, such that the ionic liquid material is exposed to be in contact with a stream of gas passing through the conduit 4. The ionic liquid medium comprises an ionic liquid physically retained by a support material, such that the ionic liquid is in contact with the electrodes 12 and 14. The ionic liquid is exposed to a stream of gas passing through the conduit 4. The arrangement of the support, electrodes 12 and 14, and the coating applied to the electrodes is shown in more detail in FIGS. 3 and 4.

Referring to FIG. 3, there is shown an exploded view of a sensor element, generally indicated as 40, comprising a substrate layer 42. A working electrode 44 is mounted on the substrate layer 42 from which extend a series of elongated electrode portions 44a. Similarly, a counter electrode 46 is mounted on the substrate layer 42 from which extends a series of electrode portions 46a. As will be seen in FIG. 3, the working electrode portions 44a and the reference electrode portions 46a extend one between the other in an intimate, interdigitated array, providing a large surface area of exposed electrode with minimum separation between adjacent portions of the working and counter electrodes. A layer 48 of ionic liquid medium overlies the working and reference electrodes 44, 46 and is shown displaced from the electrodes in FIG. 2 for clarity purposes.

An alternative electrode arrangement is shown in FIG. 4, in which components common to the sensor element of FIG. 3 are identified with the same reference numerals. It will be noted that the working electrode portions 44a and the reference electrode portions 46a are arranged in an intimate circular array. The electrodes and substrate are coated as described above in relation to FIG. 3.

Referring to FIG. 5, there is shown a potentiostat electronic circuit that may be employed to provide the voltage applied across the working and reference electrodes of the sensor of the present invention. The circuit, generally indicated as 100, comprises an amplifier 102, identified as ‘OpAmp1’, acting as a control amplifier to accept an externally applied voltage signal Vᵢₙ. The output from OpAmp1 is applied to the control (counter) electrode 104. A second amplifier 106, identified as ‘OpAmp2’ converts the passage of current from the counter electrode 104 to the working electrode 108 into a measurable voltage (Vₒᵤₜ). Resistors R1, R2 and R3 are selected according to the input voltage, and measured current.

An alternative galvanostat circuit for exciting the electrodes of the sensor is shown in FIG. 6. The counter and working electrodes 104 and 108 are connected between the input and output of a single amplifier 112, indicated as ‘OpAmp1’. Again, resistor R1 is selected according to the desired current.

Turning to FIG. 7, an adaptor for monitoring the breath of a patient is shown. A sensor element is mounted within the adaptor and oriented directly into the air stream flowing through the adaptor, in a similar manner to that shown in FIG. 2 and described hereinbefore. The preferred embodiment illustrated in FIG. 7 comprises and adaptor, generally indicated as 200, having a cylindrical housing 202 having a male-shaped (push-fit) cone coupling 204 at one end and a female-shaped (push-fit) cone coupling 206 at the other. A side inlet 208 is provided in the form of an orifice in the cylindrical housing 202, allowing for the adaptor to be used in the monitoring of the tidal breathing of a patient, as described in more detail in Example 2 below. The side inlet 208 directs gas onto the sensor element during inhalation by a patient through the device. The monitoring of tidal breathing may be improved by the provision of a one-way valve on the outlet of the housing 202.

With reference to FIG. 8 there is shown in schematic form the general layout of a sensor system according to the present invention. The system, generally indicated as 400, comprises a sensor element having a counter electrode 402 and a working electrode 404. The counter electrode 402 is supplied with a voltage by a control potentiostat 406, for example of the form shown in FIG. 5 and described hereinbefore. The input signal for the control potentiostat 406 is provided by a digital-to-analog converter (D/A) 408, itself being provided with a digital input signal from a microcontroller 410. The output signal generated by the sensing element is in the form of a current at the working electrode 404, which is fed to a current-to-voltage converter 412, the output of which is in turn fed to an analog-to-digital converter (A/D) 414. The microcontroller 410 receives the output of the A/D converter 414, which it employs to generate a display indicating the concentration of the target substance in the gas stream being monitored. The display (not shown in FIG. 8 for reasons of clarity) may be any suitable form of display, for example an audio display or visual display. In one preferred embodiment, the microcontroller 410 generates a continuous display of the concentration of the target substance, this arrangement being particularly useful in the monitoring of the tidal breathing of a patient.

Referring to FIG. 9, there is shown in cross-sectional view a representation of a portion of a sensor element of a further embodiment of the present invention, generally indicated as 502. The sensor element 502 comprises a layer of an inert substrate 504, on which a working electrode 506 has been formed by thick-screen printing. A contact 508 extends from the electrode 504 through the inert substrate 504, to enable connection to a suitable electrical circuit (not shown for clarity). A counter electrode 510 and counter electrode contact 512 are similarly formed on the substrate 504. The working and counter electrodes have a width of approximately 2 microns. A layer of ionic liquid medium 514 extends over the inert substrate 504 and covers the working electrode 504 and the counter electrode 510.

The present invention will be further illustrated by the following specific examples.

### EXAMPLES

### Example 1

A sensor element was prepared as described hereinbefore and shown in FIG. 9. The working and counter electrodes were formed from gold and thick screen printed onto an inert ceramic substrate layer. An ionic liquid medium was formed over the electrodes and inert substrate comprising titanium oxide (TiO₂) as support medium and an ionic liquid phase retained in the support medium. The ionic liquid phase contained 2.9% (w/w) 2,6-di-tert-butyl-1,4-benzoquinone dissolved in a mixture of 48.5% (w/w) of 4-(3-phenylpropyl)-pyridine (97%) and 48.5% (w/w) ionic liquid of 1-butyl-3-methyl-imidazolium hexafluorophosphate.

The sensor was connected to a circuit of the general configuration shown in FIG. 5 and a cyclic voltage signal applied across the electrodes having a scan rate of 0.1 volts per second and alternating between −1.0 and zero volts.

The sensor element was exposed to a gas stream comprising 5% carbon dioxide at a relative humidity of 80%. The output voltammogram for a single voltage scan of from 0 to −0.1 to 0 volts of the sensor is shown graphically in FIG. 10 (indicated by the lines A on the graph). The output voltammogram of the same sensor exposed to a gas stream of similar composition, but with the carbon dioxide replaced by 5% vol argon, is also shown in FIG. 10 (indicated by the lines B on the graph).

The voltammograms set out in FIG. 10 clearly show the ability of the sensor to respond to an change in the concentration of carbon dioxide in the gas stream. This response may be used to provide a measurement of the carbon dioxide concentration.

### Example 2

A sensor having the same general configuration and composition as described in Example 1 was prepared.

The sensor was connected to a circuit of the general configuration shown in FIG. 5 and a cyclic voltage signal applied across the electrodes having a scan rate of 0.1 volts per second and alternating between −1.0 and zero volts.

The sensor was exposed to a gas stream comprising 5% vol carbon dioxide at a relative humidity of 80%. The output from the sensor for two consecutive scans of from 0 to −0.1 to 0 volts is shown in FIG. 11. The first scan produced a current of −0.25 microamps at −0.1 volts, while the second produced a current of −0.2 microamps at −0.1 volts.

The composition of the gas stream was changed to replace the carbon dioxide with 5% vol argon. The scanning procedure was repeated. The output from the sensor for two consecutive scans of from 0 to −0.1 to 0 volts is shown in FIG. 12. The first scan produced a current of −0.15 microamps at −0.1 volts, while the second produced a current of −0.13 microamps at −0.1 volts.

From a comparison of the outputs represented in FIGS. 11 and 12, it can be seen that the sensor responded well to the change in carbon dioxide concentration in the gas stream, allowing the concentration of carbon dioxide to be readily measured and indicated by the sensor.

1. An electrochemical sensor comprising:
a working electrode;
a counter electrode; and
an ionic liquid medium extending between the working electrode and the counter electrode, the ionic liquid medium comprising an ionic liquid retained in a support material.

2. The sensor according to claim 1, wherein the ionic liquid comprises a cation selected from 1-alkyl-3-methylimidazolium ([CnMIM]), N-alkylpyridinium, tetraalkylammonium or tetraalkylphosphonium cations.

3. The sensor according claim 2, wherein the cation is a 1-alkyl-3-methylimidazolium ([CnMIM]) cation in which the alkyl group has from 1 to 10 carbon atoms.

4. The sensor according to claim 3, wherein the cation is 1-butyl-3-methylimidazolium (BMIM).

5. The sensor according to claim 4, wherein the ionic liquid comprises an anion selected from hexafluorophosphate [PF₆]; tetrafluoroborate [BF₄]; trifluoromethylsulfonate [CF₃SO₃]; bis[(trifluoromethyl)sulfonyl]amide [(CF₃SO₂)₂N]; trifluoroethanoate [CF₃CO₂]; acetate [CH₃CO₂]; nitrate, and halides, including fluoride [F], chloride [Cl], and bromide [Br].

6. The sensor according to claim 5, wherein the anion is hexafluorophosphate [PF₆].

7. The sensor according to claim 1, wherein the ionic liquid is 1-butyl-3-rhethylimidazolium hexafluorophosphate [BMIM][PF₆].

8. The sensor according to claim 1, wherein the support material is inert.

9. The sensor according to claim 1, wherein the support material is mesporous.

10. The sensor according to claim 9, wherein the support material comprises pores with a diameter in the range of from 1 to 75 nm, more particularly in the range of from 2 to 50 nm.

11. The sensor according to claim 1, wherein the support material comprises titanium oxide (TiO₂), aluminium oxide (Al₂O₃), zirconium oxide (zirconia, Zr₂O₄), and silicon oxide (silica, SiO₂) or a mixture thereof.

12. The sensor according to claim 1, wherein the support material comprises Titanium oxide (TiO2).

13. The sensor according to claim 1, wherein the support material is granulated or reticulated.

14. The sensor according to claim 1, further comprising a reference electrode.

15. The sensor according to claim 14, wherein the electrodes are arranged in an interlocking pattern comprising an array of interdigitated electrode portions.

16. The sensor according to claim 15, wherein the electrodes are supported on an inert substrate.

17. The sensor according to claim 16, wherein the electrodes comprise a metal selected from Group VIII metals, copper, silver and gold.

18. The sensor according to claim 17, wherein the ionic liquid medium extends as a layer over the electrodes.

19. The sensor according to claim 18, wherein the layer has a thickness of less than 500 nm.

20. The sensor according to claim 19, wherein the layer has a thickness of from 50 to 200 nm.

21. The sensor according to claim 18, wherein the ionic liquid medium further comprises an electrochemical reducing agent, in particular quinone or quinoline or a substituted derivative thereof.

22. The sensor according to claim 21, wherein the ionic liquid medium further comprises a co-solvent, in particular a nitrogen-containing organic compound, especially pyridine or a substituted derivative thereof.

23. The sensor according to claim 22, wherein the ionic liquid medium further comprises a redox catalyst, in particular a copper (II) salt, especially a copper (II) halide.

24. The sensor according to claim 23, wherein the electrodes are supported on a substrate, the electrodes having been applied to the substrate by thick film screen printing.

25. (canceled)

26. (canceled)

27. (canceled)

28. (canceled)

29. (canceled)

30. (canceled)

31. A method of detecting a target species in a gaseous medium comprising:
exposing an electrochemical sensor comprised of a working electrode, a counter electrode; and an ionic liquid medium extending between the working electrode and the counter electrode, the ionic liquid medium comprising an ionic liquid retained in a support material, to the exhaled breath of a subject.

32. The method of claim 31, wherein the target species is carbon dioxide.

33. The method of claim 32, wherein the gaseous medium is exhaled breath of the subject.

34. The method of claim 33, further comprising analyzing the output produced by the sensor to determine the concentration of CO₂ in the gaseous medium.

35. The method of claim 34, further comprising using the concentration of CO₂ in the gaseous medium determined by the sensor as a diagnostic measurement pertaining to the lung function of the subject.

36. The method of claim 35, wherein the sensor output is used in the assessment of the subject for asthma and/or COPD.
